(19) United States
(12) Patent Application Publication
(10) Pub. No.: US 2009/0279417 A1
(43) Pub. Date: Nov. 12, 2009

(54) INFORMATION RECORDING APPARATUS

(75) Inventor: Hiroshi Terui, Tokyo (JP)

Correspondence Address: DICKSTEIN SHAPIRO LLP, 1825 EYE STREET NW, Washington, DC, 20006-5403, US

(73) Assignee: RICOH COMPANY, LTD., Tokyo (JP)

(21) Appl. No.: 12/090,777

(22) PCT Filed: Oct. 24, 2006
(86) PCT No.: PCT/JP2006/321600

§ 371 Date: Apr. 18, 2008

(30) Foreign Application Priority Data
Nov. 1, 2005 (JP) 2005-318826

(51) Int. Cl. G11B 3/70

(52) U.S. Cl. 369/284; G9B/3.103

(57) ABSTRACT

An information recording apparatus is disclosed that includes a control unit that controls operations of recording user data on an information recording medium having plural recording layers. When a second layer following a first layer of the recording layers remains unrecorded at the time user data recording performed in response to a user data recording request is completed, the control unit records temporary lead-out information after the recorded user data.

### TECHNICAL FIELD

The present invention relates to an information recording apparatus that records information on a rewritable information recording medium that has plural recording layers.

### BACKGROUND ART

The DVD+RW is one type of rewritable DVD that has high playback compatibility with a single-sided single-layer read-only DVD. It is noted that a so-called background formatting process is performed on the DVD+RW in which process a formatting completion message is issued to a user at the time a portion of a lead-in area is recorded (initial processing) in response to a formatting request from the user, and dummy data are recorded on the rest of the lead-in area while the disk is not being accessed by the user by an accessing request. By employing the background formatting technique, the formatting process time that has previously been relatively long may be reduced. In the background formatting process, dummy data are sequentially recorded on a data area from the inner perimeter side. When a data recording request is issued by the user while such background formatting process is being performed, the background formatting process may be temporarily halted and the last written address (LWA) of the data area sequentially recorded with dummy data from the start address of the data may be updated to perform the data recording requested by the user. In this case, bitmap information is updated in order to identify and distinguish data-recorded areas from unrecorded areas that may be intermittently arranged within the data area. After user data recording is completed, the background formatting process may be restarted from the LWA, namely, the boundary address of the non-recorded areas.

It is noted that one of the keys to popularizing such a recording disk is to enable playback of information recorded on such a disk using a conventional playback-dedicated drive. Specifically, the disk with information recorded thereon has to maintain logical compatibility with a read-only disk (e.g., the DVD+RW has to have compatibility with the DVD-ROM). It is noted that a read-only disk is characterized by not having unrecorded areas within its information area that is made up of a lead-in area, a data area, and a lead-out area. In consideration of such a feature of the read-only disk, for example, arrangements are made on the DVD+RW so as to maintain logical compatibility with the DVD-ROM even when it is ejected from a drive before formatting is completed. Specifically, dummy data may be recorded on unrecorded areas intermittently arranged within the data area of the DVD+RW, and a temporary lead-out may be recorded at the LWA so that a provisional information area may be created. In this way, logical compatibility with the DVD-ROM may be maintained and the DVD+RW may be replayed by a DVD-ROM drive.

Also, it is noted that much research and development is being channeled into increasing the capacity of the recording disk, and one proposed measure for realizing such an objective is to increase the number of recording layers to create a multilayer disk. The recording area of a multilayer disk has a physical capacity equaling a multiple of the capacity of a corresponding single-layer disk, and therefore, increasing the number of recording layers of the recording disk may be an effective way of increasing the capacity of the recording disk. A dual layer disk such as a single-sided dual layer DVD is a typical example of a multilayer disk, and such a dual layer DVD may be a PTP (Parallel Track Path) disk or an OTP (Opposite Track Path) disk. In a PTP disk, recording layers with track paths (playback path) each directed from the inner perimeter side to the outer perimeter side are provided. In an OTP disk, a recording layer having a track path directed from the inner perimeter side to the outer perimeter side and a recording layer having a track path directed from the outer perimeter side to the inner perimeter side are provided. In the PTP disk, an information area is provided in each recording layer, and each recording layer may be regarded as independent. On the other hand, in the OTP disk, one information area is arranged to extend across the two recording layers so that the two recording layers may be regarded as one continuous recording layer. It is noted that maintaining playback compatibility with a read-only disk in a conventional playback-dedicated drive has to be considered in developing such multilayer recording disks as well. Accordingly, efforts are being made to maintain logical compatibility between a rewritable multilayer disk and a read-only multilayer disk.

It is noted that logical compatibility with a read-only multilayer disk may not be adequately ensured when a multilayer recording disk leaves unrecorded areas in its recording layers, for example. In this respect, an information recording apparatus has been proposed that records dummy data at a predetermined timing on the areas of the recording layers of a multilayer disk on which data are not recorded in order to maintain logical compatibility with a read-only disk.

Further, Japanese Laid-Open Patent Publication No. 2004-342181 discloses a technique applied to a multilayer information recording medium having at least layers 0 and 1 where data recording is completed at layer 0 (i.e., before reaching layer 1). The technique involves recording information on a lead-in area of layer 0 indicating that only this layer has data recorded thereon so that the medium may be regarded as a single-layer medium. By implementing such a measure, dummy data may not have to be recorded on layer 1, and the processing time for recording dummy data may be omitted. In turn, a playback-dedicated drive may read the information recorded on the lead-in area of layer 0, handle the medium as a single-layer medium, and properly read information recorded thereon. In this way, compatibility with the read-only medium may be maintained.

As is described above, in a DVD+RW, a LWA is recorded that indicates the last address on which data are recorded in the sequential recording of data on the data area from a start address, the LWA functioning as information for managing data-recorded areas and unrecorded areas in order to perform background formatting. In a multilayer information recording medium that is formatted through background formatting, the LWA may be used to identify an unformatted area and a formatted area having dummy data recorded thereon. However, even in a case where dummy data are recorded in at least a portion of the data area of a second layer (layer 1) of a multilayer medium in order to maintain compatibility with a read-only medium, information indicating the start address of the data-recorded area from which data are sequentially recorded up to the end address of this area is not recorded. Therefore, in order for such an information recording medium to maintain logical compatibility with a read-only medium, dummy data have to be recorded from the address on the second layer (layer 1) right above the end address (e.g., LWA) of the data recording area of the first layer (layer 0) to the end address of the data area of layer 1. In other words, even if dummy data are already recorded on the data area of layer 1, since there is no information for identifying the area of the dummy data, dummy data have to be overwritten on the second layer (layer 1) which leads to consumption of unnecessary processing time upon ejecting the information recording medium, for example.

It is noted that according to the technique disclosed in Japanese Laid-Open Patent Publication No. 2004-342181, in a case where data are only recorded on layer 0, a lead-out area may be recorded so as to eliminate the need to record dummy data. However, recording has to be restarted from layer 1, that is, the unrecorded portions of layer 0 may be wasted.

### DISCLOSURE OF THE INVENTION

According to one aspect of the present invention, an information recording apparatus for recording information on an information recording medium is provided that is capable of reducing the processing time required for ejecting the information recording medium and maintaining logical compatibility with a read-only medium.

According to one embodiment of the present invention, an information recording apparatus is provided that includes:

a control unit that controls operations of recording user data on an information recording medium having plural recording layers; wherein

when a next layer following a first layer of the recording layers remains unrecorded after user data recording in response to a user data recording request is completed, the control unit records temporary lead-out information after the recorded user data.

It is noted that in order to maintain compatibility of an information recording medium with a read-only information recording medium, the information area of the information recording medium including a lead-in area, a data area of the first layer, a middle area, a data area of the second layer, and a lead-out area, for example, must have data recorded thereon. According to an aspect of the present embodiment, compatibility with a read-only information recording medium may be maintained by merely recording a lead-in area, a data area of the first layer, and a temporary lead-out area; that is, dummy data recording of unrecorded areas within the data area of the second layer may be omitted so that the ejection process time for ejecting the information recording medium may be reduced.

In one preferred embodiment of the present invention, the control unit records lead-out information in at least an area of the next layer which area is positioned right above a lead-in area that is recorded on the first layer in an initial process. According to an aspect of the present embodiment, compatibility with a read-only information recording medium may be improved by recording lead-out information in at least an area of the next layer (i.e., the recording layer coming after the first layer) which area is positioned right above the lead-in area of the first layer recorded during an initial process.

In another preferred embodiment of the present invention, the control unit records information indicating that the information recording medium is a single layer medium in the lead-in area of the first layer. According to an aspect of the present embodiment, compatibility with a read-only information recording medium may be improved by writing information describing the information recording medium as a single layer medium rather than a dual layer medium as disk structure information of physical format information included in control data recorded in the lead-in area.

In another preferred embodiment of the present invention, the control unit records lead-out information in at least an area of the next layer which area is positioned right above a lead-in area that is recorded on the first layer in an initial process, and records information indicating that the information recording medium is a single layer medium in the lead-in area. According to an aspect of the present embodiment, compatibility with a read-only information recording medium may be improved by recording the lead-out information on the next layer, and the disk structure information describing the information recording medium as a single layer medium.

In another preferred embodiment of the present invention, in response to a user data recording request, when an unrecorded area remains in the first layer and the next layer remains unrecorded after the user data recording is completed, and a next recording request to record user data on the next layer is issued, the control unit processes the next recording request as an error. According to an aspect of the present embodiment, when the information recording medium is to be ejected after all areas of the first layer are recorded, that is, when data recording ends at the time the LWA reaches the end address of the first layer, a temporary lead-out may be recorded in a portion of the middle area. When unrecorded areas remain in the first layer, and a recording request for recording data on the next layer is issued, the recording request is handled as an error.

In another preferred embodiment of the present invention, when data recording of the first layer is completed, and data recording of the next layer is initiated, the control unit records information indicating that the information recording medium is a dual layer medium in the lead-in area of the first layer. According to an aspect of the present embodiment, information describing the information recording medium as a dual layer medium may be written as control information in the lead-in area when a recording request for recording data on the next layer is issued and unrecorded areas do not remain in the first layer at this time.

In another preferred embodiment of the present invention, the control unit records information indicating that the information recording medium is a dual layer medium in the lead-in area of the first layer when background formatting of the next layer is completed. According to an aspect of the present embodiment, in a case where a system is employed that performs background formatting from the next layer (e.g., second layer), when the information recording medium is to be ejected at the time background formatting of the second layer is completed, even if unrecorded areas still remain in the first layer, information describing the information recording medium as a dual layer medium may be written as control information in the lead-in area, and a middle area and a temporary lead-out area may be written in.

In another preferred embodiment of the present invention, the control unit records information indicating that the information recording medium is a single layer medium in the lead-in area of the first layer when data recording of the next layer is not successfully performed. According to an aspect of the present embodiment, when data recording cannot be performed on the next layer, the information recording medium may be handled as a single layer medium so that contents recorded on the first layer may not be wasted.

In another preferred embodiment of the present invention, the control unit records management information including control status information of the information recording medium in a predetermined area of the lead-in area of the first layer. According to an aspect of the present embodiment, by recording the control status of the information recording medium as management information, the manner in which the information recording medium is controlled may be determined so that the information recording medium may be adequately controlled even when it is ejected, for example.

In another preferred embodiment of the present invention, the control unit performs background formatting on the information recording medium starting from the first layer and continuing on to the next layer. According to an aspect of the present embodiment, the background formatting process may be continued on to the next layer from the first layer to thereby enable a smooth transition from operations for a single layer medium to operations for a dual layer medium.

### BRIEF DESCRIPTION OF THE DRAWINGS

FIG. 1 is a block diagram showing a configuration of an information recording apparatus according to an embodiment of the present invention;

FIGS. 2A-2C are diagrams showing the layout of different types of DVDs;

FIGS. 3A-3F are diagrams illustrating operations of a background formatting process and a user data recording process performed during the background formatting process;

FIG. 4 is a table illustrating the structure of management information stored in a management information area;

FIG. 5 is a diagram showing the layout of an information recording medium according to an embodiment of the present invention;

FIGS. 6A-6C are diagrams illustrating the layout of the information recording medium of FIG. 5 at different processing stages;

FIGS. 7A and 7B are diagrams illustrating operations of restarting a background formatting process and recording user data on the information recording medium of FIG. 5 when the information recording medium is ejected at the processing stage as is illustrated in FIG. 6C;

FIGS. 8A and 8B are diagrams illustrating the layout of the information recording medium of FIG. 5 at other different processing stages;

FIGS. 9A and 9B are diagrams illustrating the layout of the information recording medium of FIG. 5 at other different processing stages;

FIG. 10 is a table illustrating the structure of management information stored in the information recording medium of FIG. 5;

FIG. 11 is a flowchart illustrating the operations of a background formatting process;

FIG. 12 is a flowchart illustrating the operations of a user data recording process; and

FIG. 13 is a flowchart illustrating the operations of halting a de-icing process and performing a disk ejection process.

### BEST MODE FOR CARRYING OUT THE INVENTION

In the following, preferred embodiments of the present invention are described with reference to the accompanying drawings.

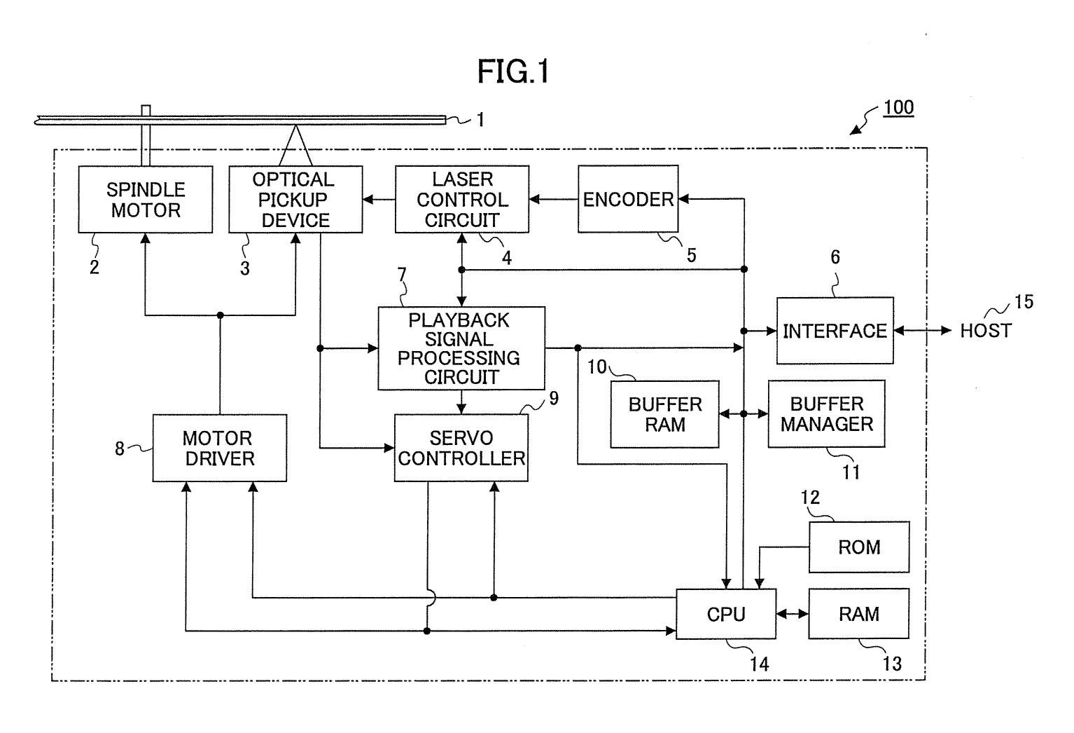

FIG. 1 is a block diagram showing an exemplary configuration of an information recording apparatus according to an embodiment of the present invention. The illustrated information recording apparatus 100 includes a spindle motor 2 that rotates and drives an optical disk 1 corresponding to an information recording medium; an optical pickup device 3 that irradiates a laser beam onto a recording surface of the optical disk 1 on which a spiral-track or concentric-tracks recording area is formed; a laser control circuit 4 that controls the laser beam output irradiated from the optical pickup device 3 based on a write signal from an encoder 5 and a command from a CPU 14; the encoder 5 that extracts data stored in the buffer RAM 10 via a buffer manager 11, processes the extracted data through data modulation and error correction code attachment, for example, generates a write signal for the optical disk 1, and outputs a signal to the laser control circuit 4 in sync with a synchronization signal from a playback signal processing circuit 7; a motor driver 8 that drives a tracking actuator and a focusing actuator of the optical pickup device 3 according to control signals from a servo controller 9, the playback signal processing circuit 7 that detects a wobble signal, an RF signal, and a servo signal (focus error signal, track error signal), for example, based on the output signal of the optical pickup device 3; the servo controller 9 that generates a control signal for correcting a focus error based on the focus error signal from the playback signal processing circuit 7, and generates a control signal for correcting a track error based on the servo track error signal from the playback signal processing circuit 7; the buffer RAM 10 as a memory; the buffer manager 11 that manages the input/output of data to/from the buffer RAM 10 and informs the CPU 14 when the amount of data stored in the buffer RAM 10 reaches a predetermined value; an interface 6 as a communication interface for establishing bidirectional communications with a host 15 (e.g., personal computer); a ROM 12 that stores a program for recording data on the optical disk 1 according to a recording request from the host 15, the program being described in code that is readable by the CPU 14; and the RAM 13 as a working memory.

It is noted that the arrows shown in the drawing illustrate general flows of information and signals; that is, the arrows do not represent all the connections between the illustrated block components. Also, in the following descriptions, it is assumed that the optical disk 1 has physical properties identical to those of the DVD+RW as one example of an information recording medium used in the present embodiment.

The optical pickup device 3 is configured to irradiate laser light onto the recording surface of the optical disk 1 on which a spiral track or concentric tracks (recording area) are formed and receive light reflected by the recording surface. The optical pickup device 3 guides light flux irradiated from a semiconductor laser as a light source onto the recording surface of the optical disk 1. The optical pickup device 3 includes an optical system that guides light flux reflected by the recording surface of the optical disk 1 to a predetermined light receiving position, an optical receiver that is positioned at this light receiving position to receive the reflected light, and a drive system (e.g., focusing actuator, tracking actuator, and seek motor (not shown)), for example. A signal according to the amount of light received is output to the playback signal processing circuit 7 from the optical receiver. The playback signal processing circuit 7 detects signals such as a wobble signal, an RF signal, and servo signals (focus error signal and track error signal) based on the output signal of the optical receiver. The playback signal processing circuit 7 extracts ADIP information and a synchronization signal from the detected wobble signal, and outputs the extracted ADIP information and the synchronization signal to the CPU 14 and the encoder 5, respectively. The playback signal processing circuit 7 performs processes such as decoding and error correction on the detected RF signal, and stores the processed data in the buffer RAM 10 via the buffer manager 11 as playback data. It is noted that the error rate in the decoding process of the RF signal is reported to the CPU 14. Also, the servo signals detected by the playback signal processing circuit 7 are output to the servo controller 9.

The servo controller 9 generates a control signal for correcting a focus error based on the focus error signal from the playback signal processing circuit 7 and a control signal for correcting a track error based on the track error signal. The generated control signals are each output to the motor driver 8. The motor driver 8 drives the tracking actuator and the focusing actuator of the optical pickup device 3 according to the control signals from the servo controller 9. As can be appreciated, tracking control and servo control are performed by the playback signal processing circuit 7, the servo controller 9, and the motor driver 8. Also, it is noted that the motor driver 8 is configured to drive the spindle motor 2 and the seek motor of the optical pickup device 3 based commands from the CPU 14.

The buffer manager 11 manages the input/output of data to/from the buffer RAM 10, and sends a notification to the CPU 14 when the amount of data accumulated in the buffer RAM 10 reaches a predetermined value. The encoder 5 extracts data stored in the buffer RAM 10 via the buffer manager 11 based on a command from the CPU 14, performs processes such as data modulation and error correction code attachment on the extracted data, generates a write signal for the optical disk 1, and outputs the write signal to the laser control circuit 4 in sync with a synchronization signal from the playback signal processing circuit 7. The laser control circuit 4 controls the output of laser light irradiated from the optical pickup device 3 based on a write signal from the encoder 5 and a command from the CPU 14. The interface 6 is a bidirectional communication interface for establishing communication with the host 15 (e.g., personal computer) and may conform to conventional interface standards such as ATAPI (Attachment Packet Interface), SCSI (Small Computer System Interface), or USB (Universal Serial Bus). The ROM 12 stores a program for recording data on the optical disk 1 according to a recording request from the host 15 which program is described by code that may be decoded by the CPU 14.

In the following, a data recording process is described. First, a control signal for controlling the rotation of the spindle motor 2 based on the recording speed is output to the motor driver 8, and a command is issued to the buffer manager 11 to accumulate user data received from the host 15 in the buffer RAM 10. Also, a message is sent to the playback signal processing circuit 7 signaling that a recording command from the host 15 has been received. In this way, when a writing start point of the optical disk 1 reaches a predetermined linear speed, tracking control and focusing control are performed. It is noted that tracking control and focusing control may be performed as is necessary or desired throughout the recording process.

When the buffer manager 11 sends a message signaling that the user data accumulated in the buffer RAM 10 has exceeded the predetermined data amount, a command is issued to the encoder 5 to generate a write signal. When the optical pickup device 3 reaches the write starting point, it sends a signal to the encoder 5. In this way, the user data may be written on the optical disk 1 via the encoder 5, the laser control circuit 4, and the optical pickup device 3. The recording process may be ended when all the user data from the host 15 are written on the optical disk 1.

In the following, a data playback process is described. First, a control signal for controlling the rotation of the spindle motor 2 based on the playback speed is output to the motor driver 8, and a message signaling that a playback request command has been received is sent to the playback signal processing circuit 7. In turn, when the read starting point of the optical disk 1 reaches a predetermined linear speed, tracking control and focusing control are performed. It is noted that tracking control and focusing control may be performed as is necessary or desired throughout the recording process. A signal is sent to the playback signal processing circuit 7 when the optical pickup device 3 reaches the read starting point. In turn, playback data are accumulated in the buffer RAM 10 via the playback signal processing circuit 7, and the playback data are handled as sector data to be transmitted to the host 15 via the buffer manager 11 and the interface 6. The playback process may be ended when all the data designated by the host 15 are replayed.

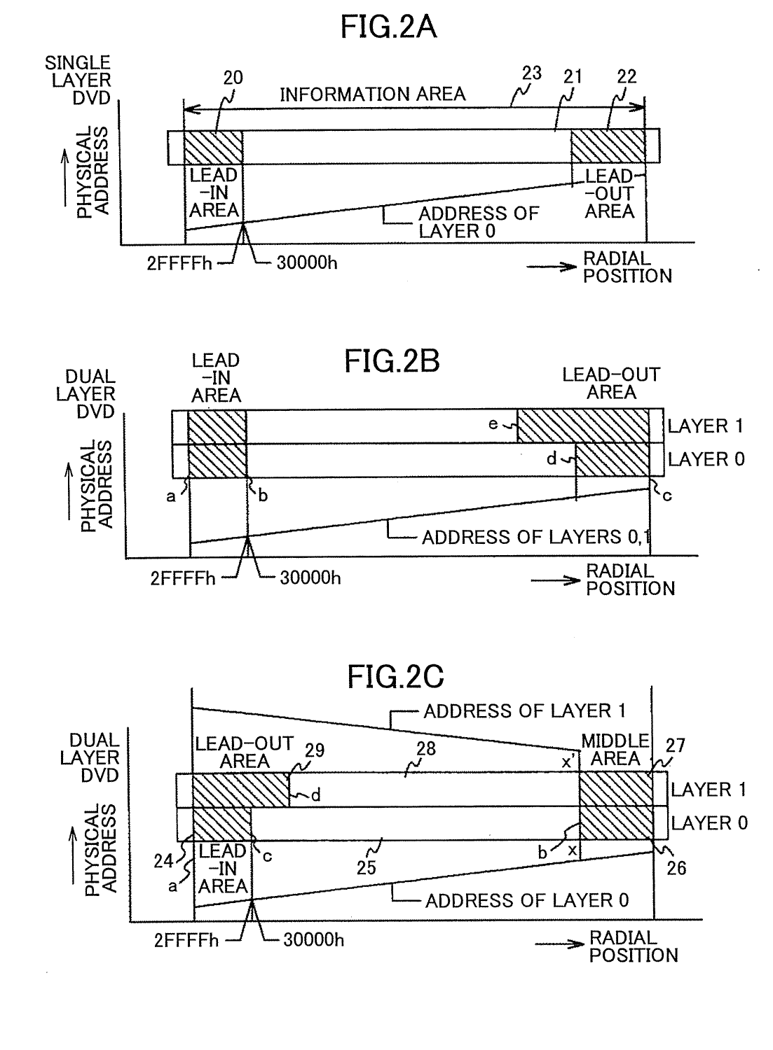

FIGS. 2A-2C are diagrams illustrating the layout of differing types of DVDs. It is noted that in these drawings, the vertical axis represents a physical address, and the horizontal axis represents the disk radial position. The DVD may be a single layer disk (referred to as single layer DVD hereinafter) having one recording layer or a dual layer disk (referred to as dual layer DVD hereinafter) having two recording layers. The dual layer DVD may be further divided into a PTP (Parallel Track Path) disk and an OTP (Opposite Track Path) disk depending on the track path (playback scanning path) configuration.

FIG. 2A shows the layout of the single layer DVD. The single layer DVD includes an information area 23 having a lead-in area 20, a data area 21, and a lead-out area 22 arranged in this order from the inner perimeter side of the disk. Also, the single layer DVD has one track path that is designed to be scanned in the direction from the lead-in area 20 to the lead-out area 22.

FIG. 2B shows the layout of the PTP disk. The PTP disk has an information area arranged on each of its recording layers (i.e., layer 0 and layer 1 in FIG. 2B). The layers 0 and 1 may be regarded as independent recording layers. The track paths of the layers 0 and 1 are each directed from the lead-in area to the lead-out area. As is shown in the drawing, in the PTP disk, the lead-in area start addresses (a), the lead-in area end addresses/data area start addresses (b), and the lead-out area end addresses (c) of the information areas of layers 0 and 1 are arranged at the same corresponding radial positions. On the other hand, the radial positions of the lead-out area start addresses/data area end addresses (d) and (e) of the information areas of layers 0 and 1 may be different. It is noted that lead-out information is recorded on remaining areas of the information areas after the end addresses of the data areas.

FIG. 2C shows the layout of the OTP disk. The OTP disk is made up of one information area, and its recording layers (i.e., layer 0 and layer 1) are regarded as one continuous recording layer. Specifically, as in the PTP disk, layer 0 of the OTP disk has a lead-in area 24 arranged at its innermost perimeter side followed by a data area 25. However, a middle area 26 is arranged at the outermost perimeter side of layer 0 rather than a lead-out area. Also, the layer 1 of the OTP disk has a middle area 27 formed at its outermost perimeter side followed by a data area 28 that extends toward its inner perimeter, and a lead-out area 29 formed at the innermost perimeter side. The track path of the OTP disk is directed such that scanning may be performed on the data area 25 of layer 0 from the lead-in area 24 at the inner perimeter side of layer 0 toward the middle area 26, and after reaching the middle area 27, the scanning direction is switched so that scanning is performed on the data area 28 of layer 1 from the middle area 27 toward the lead-out area 29 at the inner perimeter side of layer 1. In this case, layers 0 and 1 are handled as a single continuous layer. As is shown in the drawing, in the OTP disk, the lead-in area start address and the lead-out area end address (a), the data area end address of layer 0 and the data area start address of layer 1 (b), and the start addresses and end addresses of the middle areas of the recording layers are respectively arranged at the same radial positions. On the other hand, the data area start address of layer 0 (c) and the data area end address of layer 1 (d) do not necessarily have to be at the same radial position. It is noted that in the OTP disk, lead-out information is recorded on the remaining areas of the information area following the end address of the data area.

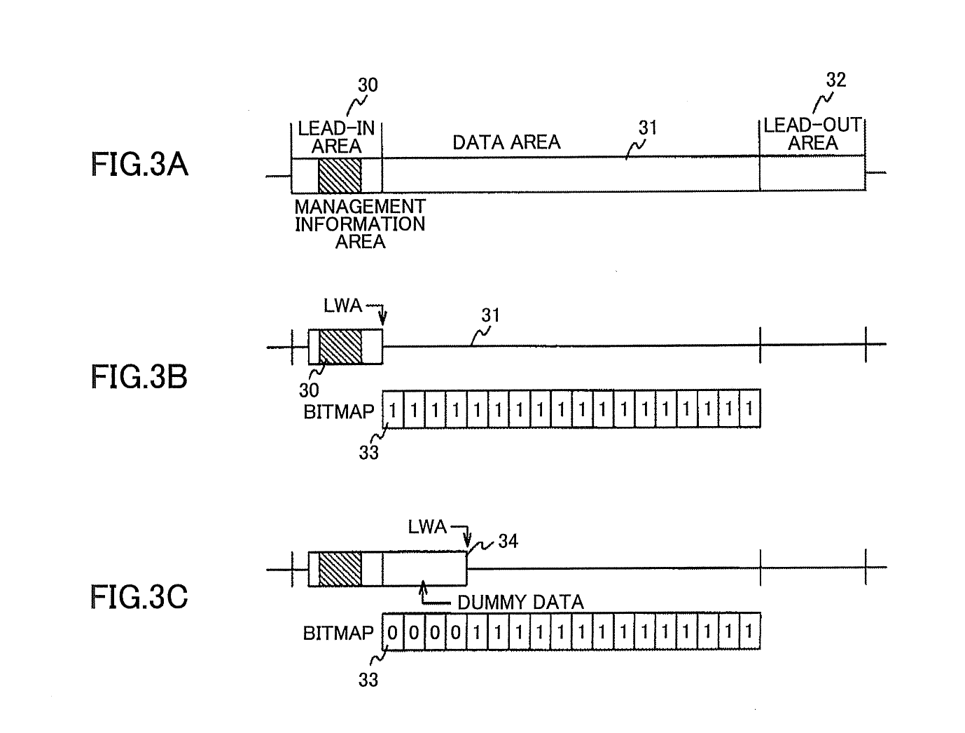

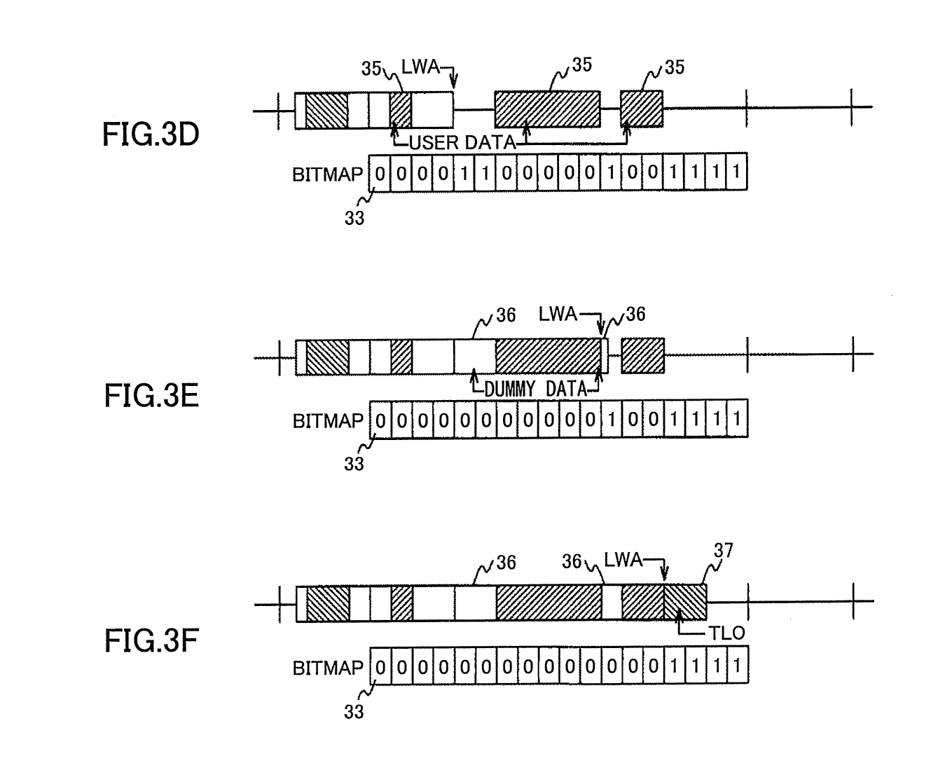

FIGS. 3A-3F are diagrams illustrating background formatting operations and user data recording operations performed during background formatting. Normally, recording disks sold on the market have disk surfaces that are entirely blank (unrecorded), and a so-called formatting process for forming a predetermined recording pattern on the disk surface has to be performed on the recording disk before a user can record data on the disk. With the growing trend toward increasing the disk capacity, the process time required for formatting the disk has also increased so that the formatting process may become an obstacle to performing efficient user operations on the disk. The background formatting technique has been developed in view of such circumstances. In the illustrated example, the DVD+RW is shown as an example of an information recording medium on which background formatting operations are performed.

As is shown in FIG. 3A, the DVD+RW basically has a layout similar to that of the single layer DVD. That is, the DVD+RW includes a lead-in area 30, a data area 31, and a lead-out area 32 arranged in this order from the inner perimeter side of the disk, and user data may be recorded on the data area 31. The lead-in area 30 includes a management information area storing management information as information that is unique to the DVD+RW for managing the background formatting process and areas on which data have been recorded during the background formatting process. The management information may include information such as the last written address (LWA) representing the last address of the area up to which sequential recording has been performed from the start address of the data area, and bitmap information for identifying the area within the data area on which user data have been randomly recorded during background formatting, for example.

FIG. 3B illustrates a case in which an initial process of background formatting is performed on the DVD+RW. In background formatting, a formatting completion message is sent to the user after just recording a portion of the lead-in area 30 (initial process) in response to a formatting request from the user. In other words, the user may assume that the formatting process is completed when only the initial process is completed. Accordingly, the user may record/replay data to/from the data area of the disk after the initial process is completed. As can be appreciated, by implementing background formatting, the formatting process time required before the user may use the disk may be significantly reduced. It is noted that at the time the initial process is completed, the initial value of the LWA may be regarded as the start address of the data area (or end address of the lead-in area). In this case, since the data area 31 is still unrecorded, “1” as information representing an unrecorded state is set in the bitmap 33.

Then, as is shown in FIG. 3C, in the background formatting process, dummy data are recorded on unrecorded areas 34 of the data area 31 from the inner perimeter side. It is noted that dummy data recording on the DVD+RW is referred to as de-icing. The de-icing process is sequentially performed from the start of the data area, and the LWA is updated according to the progress of the de-icing process. The bitmap 33 corresponding to the areas on which the dummy data are recorded is set to “0” indicating a recorded state.

When a data recording request is issued from the user during the background formatting process as is shown in FIG. 3D, the de-icing process is temporarily halted so that user data 35 may be recorded. It is noted that in this case, the user may record data at any location of the data area including unrecorded areas where the de-icing process is not yet performed as is shown in the drawing. Thus, the bitmap 33 is provided in the management information area of the DVD+RW in order to prevent dummy data overwriting on the areas where user data are recorded when the de-icing process is restarted. As is shown in the drawing, when user data 35 are recorded, bitmap information corresponding to the areas on which the user data 35 have been recorded is updated accordingly.

After the user data recording is completed, the de-icing process is restarted as is shown in FIG. 3E. In the present example, the LWA is referred to as the de-icing start address, and the unrecorded areas of the data area are identified by referring to the bitmap 33. In other words, upon restarting the de-icing process, dummy data recording is performed on unrecorded areas 36 coming after the LWA. It is noted that upon performing the dummy data recording, the LWA and the bitmap 33 are updated accordingly.

Also, in the present example, background formatting of the DVD+RW may be halted to eject the DVD+RW. The disk may be ejected with the data area having recorded and unrecorded areas intermittently arranged; in this case, logical compatibility with a read-only DVD cannot be ensured. As is shown in FIG. 2A, the information area of a read-only DVD has to have a lead-in area, a data-area, and a lead-out area all filled with data.

Thus, as is shown in FIG. 3F, in the present example, the following measures are taken in order to ensure logical compatibility with a read-only DVD when the DVD+RW is ejected while background formatting is still being performed on the DVD+RW. Specifically, first, the bitmap 33 is referenced, and unrecorded areas intermittently arranged within the data area are filled with dummy data. As a result, the LWA is updated to the end address of the last section of the data area on which data are recorded as is shown in FIG. 3F. Then, a temporary lead-out 37 (referred to as TLO hereinafter) is recorded after the LWA. In this way, an information area including a lead-in area, a data area (up to the LWA), and a (temporary) lead-out area may be formed so that the DVD+RW may be replayed by a playback-dedicated DVD drive, for example. As is shown in this drawing, the bitmap information corresponding to the area on which the TLO 37 is recorded is set to “1” indicating that the area is unrecorded. Generally, data having different attributes are recorded on the data area and the lead-out area. The TLO 37 of the DVD+RW is filled with data having a data attribute representing a lead-out area. It is noted that when the background formatting process is restarted, the de-icing process is restarted by overwriting dummy data on the LWA and TLO. Accordingly, the bitmap information corresponding to the temporary middle area (i.e., LWA and TLO) is set with information representing an unrecorded state. In this way, when the disk processed in the above manner is re-inserted into a drive, the de-icing process may be restarted from the LWA to overwrite dummy data on the TLO.

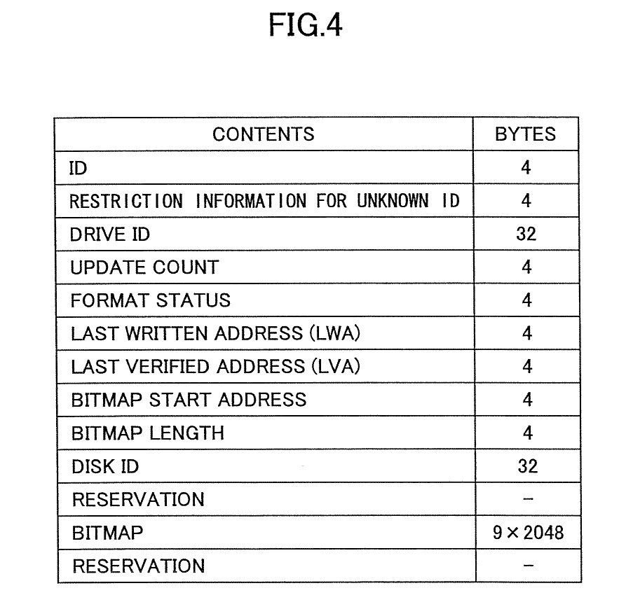

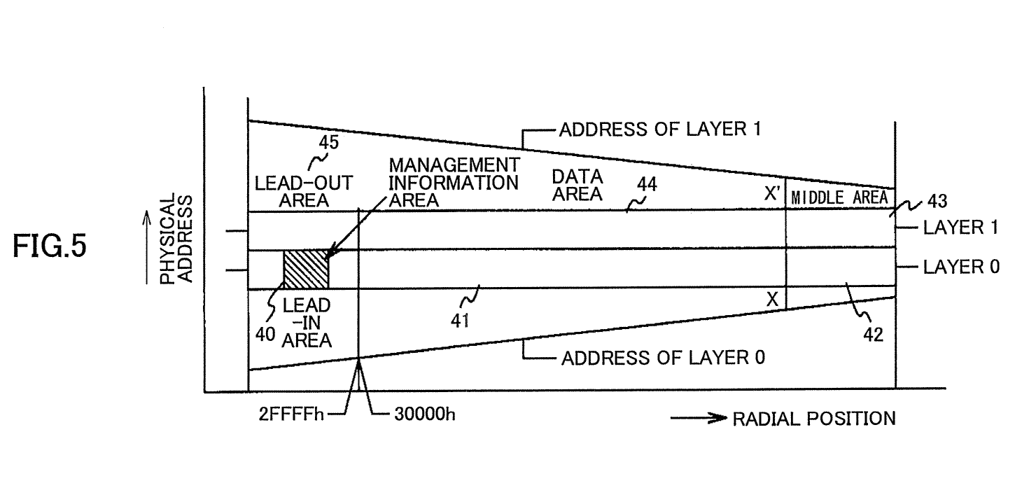

FIG. 4 is a table illustrating a structure of management information stored in a management information area. The illustrated management information includes the information items “ID”, “restriction information for unknown ID”, “drive ID”, “update count”, “format status”, “last written address”, “last verified address”, “bitmap start address”, “bitmap length”, “disk ID”, and “bitmap”. It is noted that for the information item “ID”, an ID for identifying the management information is stored. For the information item “restriction information for unknown ID”, there is stored information pertaining to restricted operations that a drive apparatus is not to perform when the ID is unknown. Examples of such restricted operations include prevention of data recording on a data area and prevention of formatting. As for the information item “drive ID”, ID information for identifying the drive apparatus that has recorded the management information is stored. As for the information item “update count”, information on the number of times the management information has been updated is stored. As for the information item “format status”, information pertaining to the background formatting status is stored. Examples of the format status include an unformatted status, a formatting incomplete status, and a formatted status. As for the information item “last written address”, the last address of an area on which sequential recording has been performed from the start address of the data area is stored. As is described above, in the case of restarting the background formatting process, dummy data are recorded from the boundary address indicated by the LWA. As for the information item “last verified address”, the last address of an area on which sequential verification is performed from the start address of the data area is stored. When verification is not performed, the information is described as “000000000h” in the corresponding area. As for the information item “bitmap start address”, an address corresponding to the first bit of a bitmap area within the data area is stored. As for the information item “bitmap length”, the size of the data area subject to recorded/unrecorded status management by the bitmap is stored. As for the information item “disk ID”, an ID for identifying the present disk is stored. Also, bitmap information is stored as the information item “bitmap”.

In the following, the bitmap is described in greater detail. As is described above, in background formatting, user data recording may be performed on any area within the data area after the initial process is completed. Specifically, user data may be recorded on areas that are not yet filled with dummy data by the de-icing process. Therefore, when user data recording is performed during background formatting, data-recorded areas and unrecorded areas may be intermittently arranged across the data area. When the de-icing process is restarted under such conditions, dummy data have to be recorded on areas other than those having user data recorded thereon. In this respect, in the DVD+RW, for example, the recorded/unrecorded state of an area corresponding to an ECC block (16 sectors) as a recording unit may be identified by a one-bit flag, namely, bitmap information. When user data are recorded on certain areas within the data area, flags of the bitmap corresponding to the recorded areas are set to represent recorded states. Then, when the de-icing process is restarted, the bitmap information may be referenced in order to record dummy data only on the unrecorded areas within the data area. As can be appreciated, user data recorded during background formatting may be prevented from being overwritten by dummy data by referring to the bitmap information.

FIG. 5 is a diagram showing a layout of an information recording medium according to an embodiment of the present invention. The illustrated information recording medium is a single-sided dual layer OTP disk that basically has a layout similar to that of the dual layer OTP DVD shown in FIG. 2C. Specifically, the illustrated information recording medium includes a first layer (layer 0) having a lead-in area 40 arranged at the innermost perimeter side, followed by a data area 41, and a middle area 42 arranged at the outermost perimeter side. The illustrated medium further includes a second layer (layer 1) having a middle area 43 arranged at the outermost perimeter side, followed by a data area 44 extending toward the inner perimeter side, and a lead-out area 45 arranged at the innermost perimeter side. The track path of the present medium is directed so that the data area 41 of layer 0 is scanned from the lead-in 40 toward the middle area 42, and when the middle area 43 is reached, the scanning direction is switched and the data area 44 of layer 1 is scanned in a direction toward the lead-out area 45 at the inner perimeter side of the disk. In the present embodiment, the layers 0 and 1 are handled as one single layer.

In the following descriptions, it is assumed that background formatting is performed on the illustrated information recording medium of FIG. 5, and user data are recorded at the time unrecorded areas still remain in the data area. Accordingly, a management information area is recorded in the lead-in area for managing information pertaining to the background formatting process and the areas on which data are recorded during the background formatting process.

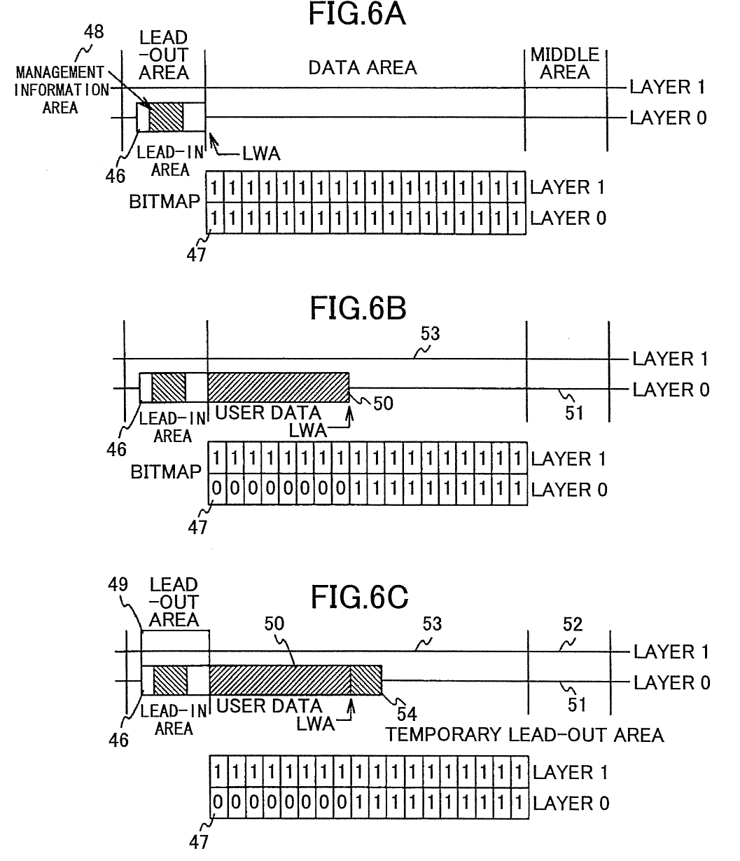

FIGS. 6A-6C are diagrams illustrating operations performed on the information recording medium of FIG. 5. According to the present embodiment, background formatting is performed on the information recording medium to reduce the process time required before user data may be recorded. Specifically, user data may be recorded after a portion of a lead-in area 46 is recorded by an initial process. It is noted that a description of dummy data recording (de-icing) to be performed while access is not being made by the user is omitted to simplify the descriptions of the present embodiment. Also, it is noted that user data may be sequentially recorded from the start address of the data area of layer 0 (such user data recording process is omitted from the present descriptions as well).

FIG. 6A illustrates the information recording medium at the time an initial process of background formatting is completed. In the present embodiment, a LWA (first pointer) and a bitmap (identification information) 47 are stored as management information related to recording during background formatting in a management information area 48. It is noted that the LWA is an address within the data area of layer 0 or layer 1 corresponding to the last address of an area on which data are sequentially recorded from the start address of the data area of layer 0. It is noted that in an OTP medium the layers 0 and 1 are regarded as one continuous layer, and therefore, the LWA may be regarded as the end address of the area on which data are sequentially recorded from the start address of this pseudo data area. At the time the initial process is completed (before a de-icing process is performed), the start address of the data area of layer 0 (or the end address of the lead-in area) as is shown in FIG. 6A is assumed to be the initial value of the LWA. At this stage since the data area is completely blank (unrecorded), all the flag values of the bitmap 47 are set to “1” representing an unrecorded state.

FIG. 6B illustrates the information recording medium after the initial process is completed and user data recording is performed. In the present embodiment, user data are sequentially recorded from the start address of the data area. As is shown in this drawing, the LWA is updated in accordance with the progress of the user data recording, and the bitmap 47 corresponding to the area on which user data are recorded is set to “0”.

FIG. 6C illustrates the information recording medium in a case where background formatting is temporarily halted and the information recording medium as is illustrated in FIG. 6B is ejected. In order to maintain logical compatibility with a read-only disk, data may conventionally have to be recorded on the information area including a lead-in area 46, a layer 0 data area 50, middle areas 51 and 52, a layer 1 data area 53, and a lead-out area 49. However, in the present embodiment, data are only recorded on the lead-in area 46, the layer 0 data area 50, and a temporary lead-out area 54 to speed up the ejection process. In other words, dummy data recording of the unrecorded areas within the data area 53 of layer 1 at the same radial position as the data area 50 is omitted in the present embodiment so that the process time may be reduced.

In one preferred embodiment, at least a lead-out area 49 positioned right above the lead-in area 46 recorded in the initial process is recorded on layer 1 in order to improve compatibility with a read-only disk.

In another preferred embodiment, disk structure information describing the present medium as single layer rather than dual layer as physical format information of control data may be recorded in the lead-in area in order to improve compatibility with a read-only disk.

Also, the above preferred embodiments may be combined to further improve compatibility with the read-only disk.

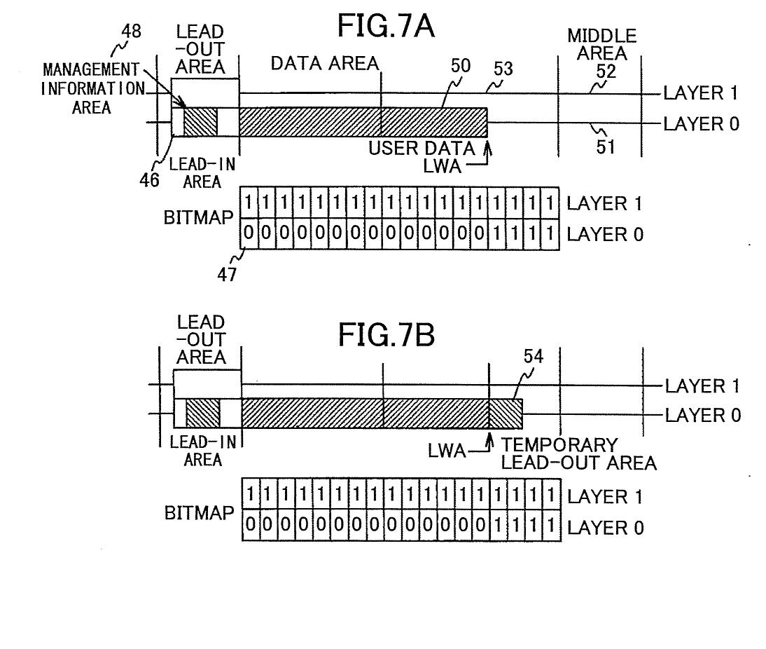

FIGS. 7A and 7B are diagrams illustrating operations of restarting the background formatting process and performing user data recording thereafter. As is described above, in the case of restarting the background formatting process, a de-icing process is restarted from the LWA (a description of the de-icing process is omitted in the present descriptions as well).

FIG. 7A shows the information recording medium in a case where user data are newly recorded after the background formatting process has been restarted. It is noted that in the drawings, component elements that are identical to those shown in FIGS. 6A-6C are given the same reference numerals. As is shown in the drawing, the LWA is updated in accordance with the user data recording, and in turn, the corresponding bitmap information 47 is set to “0” representing a recorded state.

FIG. 7B illustrates the information recording medium in a case where the background formatting process is halted once again, and the information recording medium as is illustrated in FIG. 7A is ejected. In this case, a temporary lead-out area 54 is recorded in a manner similar to the example of FIG. 6C so that the process time required before enabling ejection of the information recording medium may be reduced. Specifically, in the present embodiment, recording of dummy data on unrecorded areas within the data area of layer 1 located at the same radial positions as the data-recorded areas within the data area of layer 0 is omitted so that the process time may be reduced.

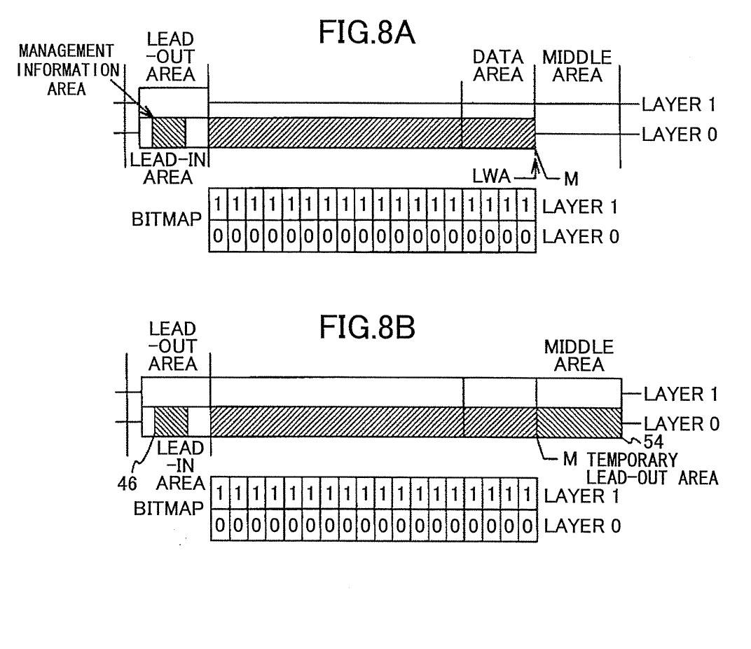

FIG. 8A is a diagram illustrating the information recording medium in a case where data recording of the first layer (layer 0) of the information recording medium is completed. FIG. 8B is a diagram illustrating the information recording medium in a case where the information recording medium as is illustrated in FIG. 8A is ejected. It is noted that in these drawings, component elements that are identical to those shown in FIGS. 6A-6C are given the same numerical references. As is shown in FIG. 8B, when data recording is ended at the time the LWA reaches the end address of layer 0, a temporary lead-out area 54 is recorded in a portion of the middle area of layer 0. It is noted that when a recording request to record data on the second layer (layer 1) is issued when unrecorded areas still remain in the first layer (layer 0) as in the cases illustrated in FIGS. 6A-6C and FIGS. 7A and 7B, an error message is generated in response to the recording request. On the other hand, when there are no unrecorded areas remaining in the first layer as is shown in FIGS. 8A and 8B, dual layer disk information is written as the disk structure information of the physical format information of the control data in the lead-in area in response to the recording request for recording data on the second layer (layer 1).

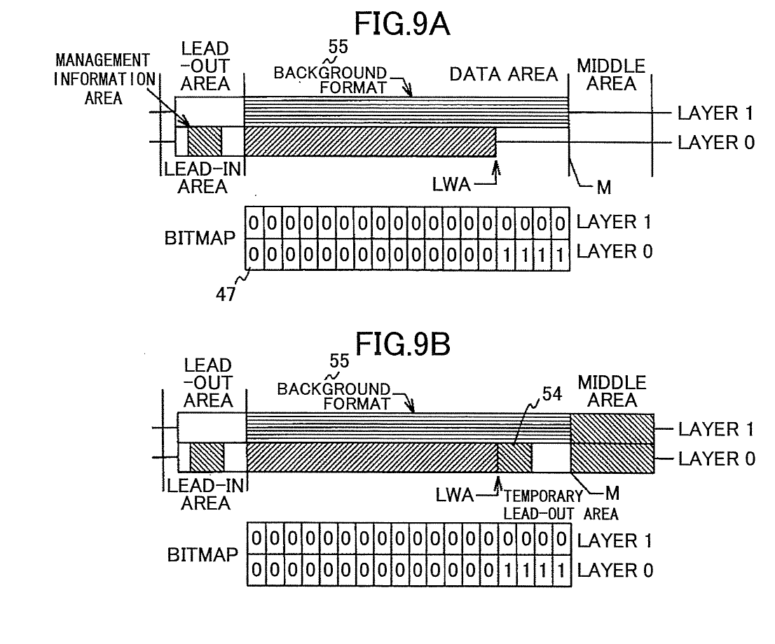

FIG. 9A illustrates the information recording medium in a case where a system that starts background formatting from the second layer (layer 1) is implemented and background formatting of the second layer (layer 1) is completed. FIG. 9B illustrates the information recording medium in a case where the information recording medium as is illustrated in FIG. 9A is ejected. According to the present embodiment, even if unrecorded areas remain in the first layer (layer 0), when recording of background format information 55 on the second layer (layer 1) is completed, dual layer disk information is written as the disk structure information of the physical format information of the control data in the lead-in area, and temporary lead-out information and middle area information are written. As can be appreciated, FIGS. 6A through 9B illustrate embodiments of an information recording medium and information recording apparatus operations that use background formatting. It is noted that in these descriptions, operations of dummy data recording by a de-icing process and random user data recording are not described. Such data recording operations may be performed according to a sequential recording scheme for sequentially recording data from the start address of a data area, for example.

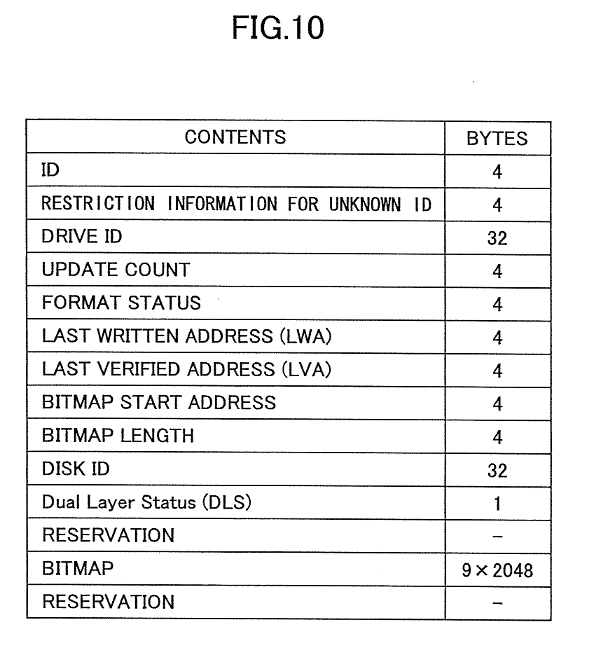

FIG. 10 is a table illustrating the structure of management information stored in the information recording medium according to the present embodiment as is described above. The illustrated management information has a data structure substantially identical to the management information illustrated in FIG. 4. Accordingly, features of the management information of FIG. 10 identical to those of FIG. 4 are omitted from description, and features of the present management information that are different from FIG. 4 are described below.

The present management information includes the information items “ID”, “restriction information for unknown ID”, “drive ID”, “update count”, “format status”, “last written address”, “last verified address”, “bitmap start address”, “bitmap length”, “disk ID”, “dual layer status”, and “bitmap”.

It is noted that the information items “ID”, “restriction information for unknown ID”, “drive ID”, “update count”, and “format status” may be identical to the corresponding information items of the management information of FIG. 4. As for the information item “last written address (LWA)”, the last address of an area on which data are sequentially recorded from the start address of the data area of layer 0 is stored. It is noted that in the present embodiment, the data area of layer 0 and the data area of layer 1 are regarded as one continuous pseudo data area. Therefore, when data are recorded on all areas of layer 0, the LWA is updated to an address on layer 1. As for the information item “last verified address”, the last address of an area on which verification is performed from the start address of the pseudo data area is stored. It is noted that in a case where verification is not performed on the information recording medium “00000000h” is recorded in the corresponding area. As for the information item “bitmap start address”, an address within the data area corresponding to the first bit of a bitmap area indicating recorded/unrecorded states of the pseudo data area is stored. As for the information item “bitmap length”, the size of the area managing information pertaining to recorded/unrecorded states of the pseudo data area by a bitmap is stored. As for the information item “disk ID”, an ID for identifying the present information recording medium is stored. As for the information item “dual layer status”, information pertaining to the disk layer structure of the information recording medium is stored. As for the information item “bitmap”, bitmap information pertaining to the pseudo data area is stored.

As can be appreciated from the above descriptions, the data structure of the present management information is generally identical to that of the management information of FIG. 4 aside from the fact that the information item “dual layer status” is added.

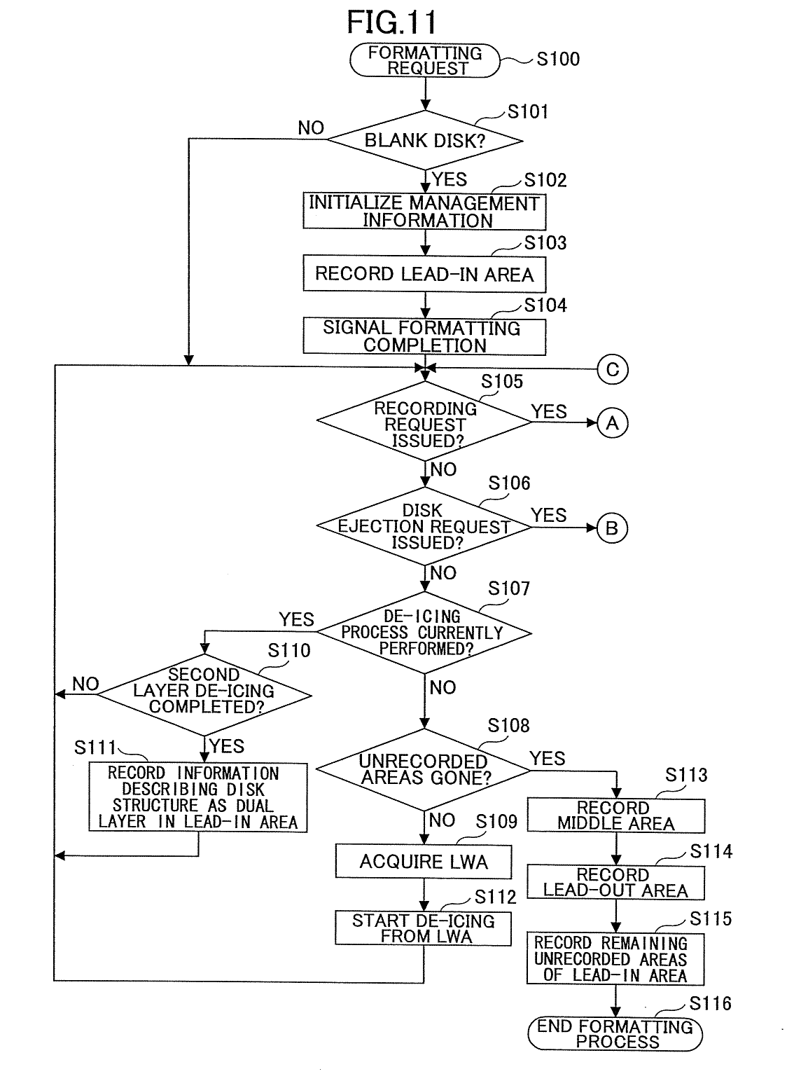

In the following, a background formatting process, a data recording process performed during background formatting, and a disk ejection process performed during background formatting by an information recording apparatus according to an embodiment of the present invention are described with reference to FIGS. 11 through 13.

FIG. 11 is a flowchart illustrating a background formatting process according to an embodiment of the present invention. According to this flowchart, when a formatting request is issued by a user (step S100), a determination is made as to whether the disk (information recording medium) presently inserted in the information recording apparatus is a blank disk (step S101). If the inserted disk is a blank disk (step S101, Yes), the management information as is shown in FIG. 10 is initialized (step S102), a portion of a lead-in area is recorded (step S103), and a message signaling formatting completion is issued to the user (step S104). At this point, the information recording medium may have data recorded thereon as is shown in FIG. 6A. Specifically, data are recorded on a portion of the lead-in area including the management information, and the LWA is initially set to the start address of the data area of layer 0 (or end address of the lead-in area). Also, information indicating that all areas within the data area are unrecorded is set in the bitmap. After performing the initial process as is described above, the information recording apparatus of the present embodiment performs a de-icing process involving recording dummy data on the information recording medium by background formatting. On the other hand, if the inserted disk is not blank, that is, if formatting of the disk has previously been started (step S101, No), the steps S102 through S104 are skipped and the process proceeds directly to the de-icing process.

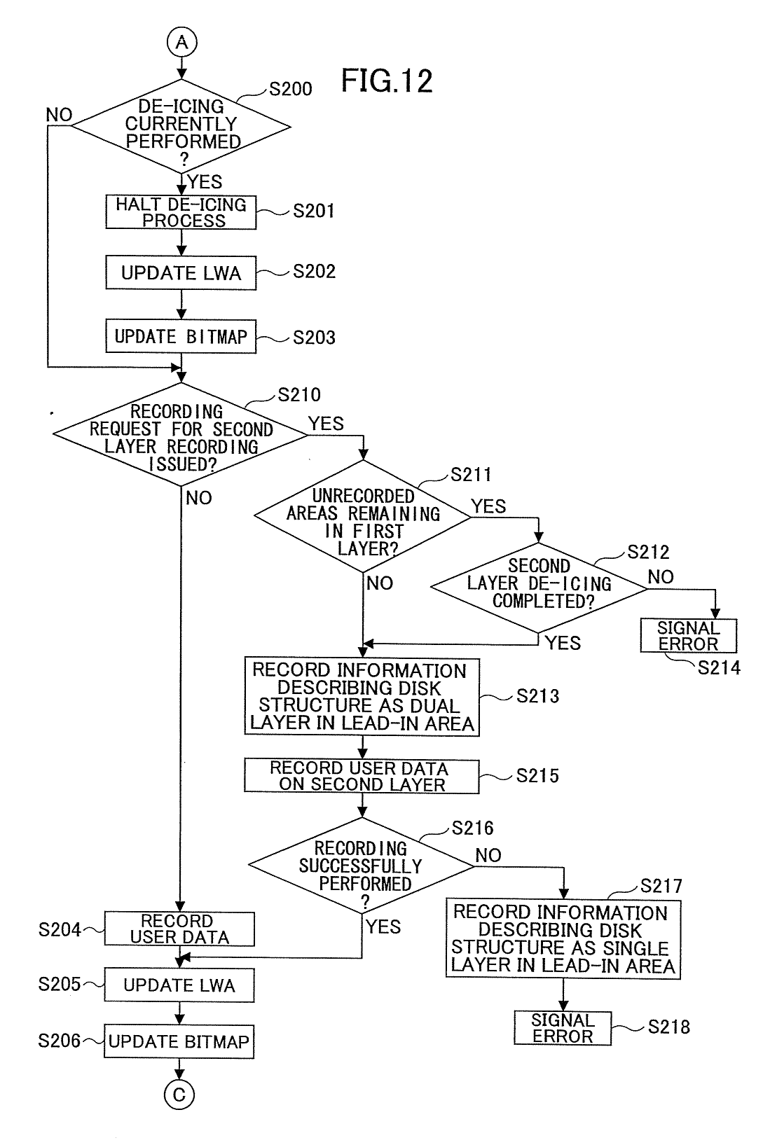

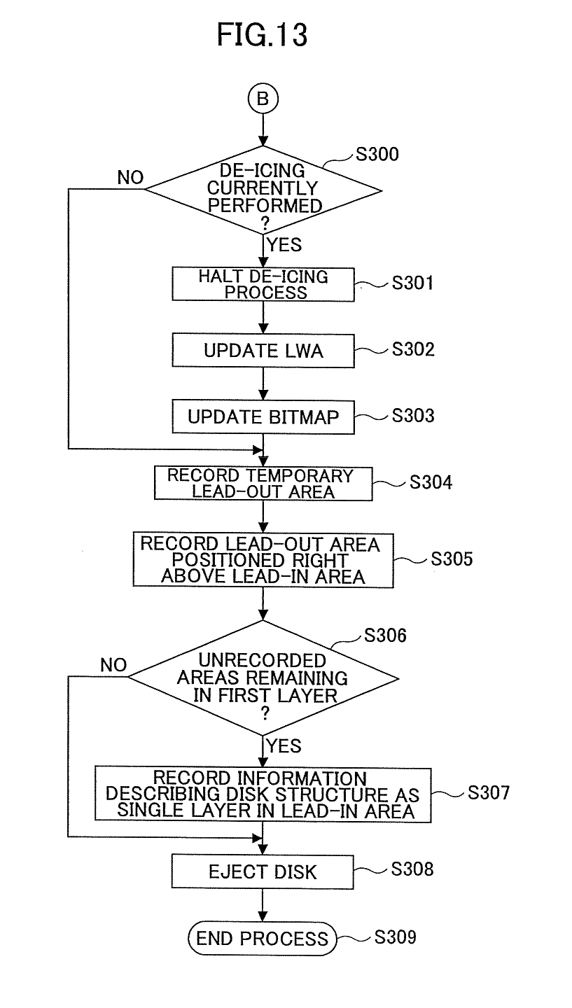

In the de-icing process, first, a determination is made as to whether a recording request has been issued by the user (step S105). If a recording request is issued by the user (step S105, Yes), the de-icing process is temporarily halted so that user data recording may be performed. It is noted that the user data recording process is described in detail below with reference to FIG. 12. If no recording request is issued by the user (step S105, No), the process moves on to the next step of determining whether a disk ejection request has been issued by the user (step S106). If a disk ejection request has been issued by the user (step S106, Yes), the de-icing process is temporarily halted, and a disk ejection process is performed. It is noted that the disk ejection process is described in detail below with reference to FIG. 13. If no disk ejection request is issued by the user (step S106, No), a determination is made as to whether the de-icing process is being performed (step S107). If the de-icing process is being performed (step S107, Yes), a determination is made as to whether de-icing of the second layer of the disk has been completed (step S110). If de-icing of the second layer is completed (step S110, Yes), information describing the disk structure as dual layer is recorded in the lead-in area (step S111). If de-icing of the second layer is not completed (step S110, No), the process goes back to step S105 to wait for issuance of another recording request from the user. During this time, dummy data are recorded on the information recording medium in the background by the de-icing process. On the other hand, if the de-icing process in not being performed (step S107, No), a determination is made as to whether unrecorded areas exist within the data area (step S108). For example, in a case where the initial process has just been completed for the information recording medium as is shown in FIG. 6A, all areas within the data area are still unrecorded, and thereby a negative determination is made in step S108.

If unrecorded areas exist within the data area (step S108, No), first, the information recording apparatus refers to the management information in order to acquire the LWA (step S109), and then, the information recording apparatus starts the de-icing process from the address indicated by the LWA (step S112). In the de-icing process, the bitmap is referred to in order to record dummy data only on unrecorded areas, that is, to avoid recording the dummy data on areas where user data are recorded. After the de-icing process is started, the process goes back to step S105 to wait for issuance of another recording request.

On the other hand, if unrecorded areas do not exist within the data area (step S108, Yes), a signal is issued indicating that the de-icing process has been completed. In this case, the middle area is recorded on (step S113), the lead-out area is recorded on (step S114), and the remaining unrecorded areas of the lead-in area are recorded on (step S115) to thereby end the formatting process (step S116). It is noted that there may be cases in which the lead-out area is already recorded before the de-icing process is completed such as when the disk is ejected in compatible mode with a read-only disk as is described in detail below. In such cases, step S114 for recording on the lead-out area may not have to be performed. In one embodiment, information indicating whether the lead-out area is recorded may be stored as part of the management information shown in FIG. 10 (e.g., as the information item “format status”), and the lead-out area may be recorded on in step S114 when it is determined based on the above information that the lead-out area is not yet recorded.

As is described above, when a recording request is issued by the user in step S105, the background formatting process is temporarily halted and a user data recording process is performed. In the following such a user data recording process is described with reference to FIG. 12.

According to FIG. 12, first, a determination is made as to whether the de-icing process is being performed (step S200). If the de-icing process is being performed (step S200, Yes), the de-icing process is temporarily halted (step S201), the LWA is updated (step S202), and the bitmap is updated (step S203). Then, a determination is made as to whether the recording request is for recording on the second layer (step S210). If the recording request is for recording on the second layer (step S210, Yes), a determination is made as to whether unrecorded areas remain within the first layer (step S211). If unrecorded areas do not remain within the first recording layer (step S211, No), information describing the disk structure as dual layer is recorded in the lead-in area (step S213), and the user data recording on the second layer is performed (step S215). Then, a determination is made as to whether user data recording of the second layer has been successfully performed (step S216). If the user data recording has been successfully performed (step S216, Yes), the LWA is updated (step S205). If the user data recording has not been successfully performed (step S216, No), information describing the disk structure as single layer is recorded in the lead-in area (step S217), and an error message is issued (step S218). Also, if unrecorded areas exist within the first layer (step S211, Yes), a determination is made as to whether de-icing of the second layer has been completed (step S212). If the de-icing of the second layer has been completed (step S212, Yes), the process moves on to step S213. If the de-icing of the second layer is not completed (step S212, No), an error message is issued (step S214).

If the recording request is for recording on the first layer (step S210, No), user data recording is performed as is requested by the user (step S204), the LWA is updated based on the user data recorded areas (step S205), and the bitmap is updated (step S206). After the user data recording process as is described above is completed, the process goes back to step S105 to wait for the issuance of another recording request.

Also, as is described above, when a disk ejection request is issued by the user in step S106, the de-icing process is temporarily halted and a disk ejection process is performed. In the following, the halting of the de-icing process and the disk ejection process are described with reference to FIG. 13.

According to FIG. 13, first, a determination is made as to whether the de-icing process is being performed (step S300). If the de-icing process is being performed (step S300, Yes), the de-icing process is temporarily halted (step S301), the LWA is updated (step S302), and the bitmap is updated (step S303). Then, a temporary lead-out area is recorded (step S304), a lead-out area situated right above the lead-in area is recorded (step S305), and a determination is made as to whether unrecorded areas exist within the first layer (step S306). If unrecorded areas exit within the first layer (step S306, Yes), information describing the disk structure as single layer is recorded in the lead-in area (step S307). If unrecorded areas do not exist within the first layer (step S306, No), the disk is ejected (step S308), and the process is ended (step S309).

According to an embodiment of the present invention, the information recording apparatus 100 as is shown in FIG. 1 may be configured to perform the processes described above via the CPU 14.

In such an embodiment, after completing user data recording on the optical disk 1 in response to a user data recording request, if recording areas of the second layer of the optical disk 1 are unrecorded, the CPU 14 of the information recording apparatus records a temporary lead-out after the recorded user data in order to maintain logical compatibility with a read-only disk. In this way, the time required for ejecting the optical disk 1 may be reduced.

In a preferred embodiment, the CPU 14 records a lead-out on at least an area of the second layer positioned right above the lead-in area that is recorded in the initial process in order to maintain logical compatibility with a read-only disk. In this way, the time required for ejecting the disk may be reduced, and compatibility with a read-only disk may be improved.

In another preferred embodiment, the CPU 14 records information indicating that the optical disk is a single layer disk in the lead-in area in order to maintain compatibility with a read-only disk. In this way, the time required for ejecting the disk may be reduced, and compatibility with a read-only disk may be improved.

In another preferred embodiment, the CPU 14 records a lead-out on at least an area of the second layer positioned right above the lead-in area that is recorded in the initial process and records information indicating that the optical disk is a single layer disk in the lead-in area in order to maintain compatibility with a read-only disk. In this way, the time required for ejecting the disk may be reduced, and compatibility with a read-only disk may be improved.

In another preferred embodiment, after user data recording is performed in response to a user data recording request, if unrecorded areas exist within the first layer of the optical disk 1 and the second layer of the optical disk 1 is unrecorded (blank), and a user data recording request for recording the second layer is issued, the CPU 14 processes the recording request as an error. In this way, user data recording of the second layer may be avoided in a case where unrecorded areas still remain within the first layer and the optical disk 1 may be handled as a single layer disk so that the ejection process time may be reduced.

In another preferred embodiment, the CPU 14 records information describing the optical disk 1 as a dual layer disk in the lead-in area when data recording of the first layer is completed and data recording of the second layer is to be initiated. In this way, the CPU 14 prevents the second layer from having data recorded thereon when unrecorded areas still remain in the first layer so that the optical disk 1 may be handled as a single layer disk until all areas of the first layer have data recorded thereon to thereby reduce the time required for ejecting the optical disk 1.

In another preferred embodiment, the CPU 14 records information describing the optical disk as a dual layer disk in the lead-in area when background formatting of the second layer of the optical disk 1 is completed. According to this embodiment, when unrecorded areas remain in the first layer, the optical disk 1 is handled as a single layer disk, and when background formatting of the second layer is completed, the disk structure information of the optical disk 1 is switched to information describing the optical disk 1 as a dual layer disk. In this way, the time required for ejecting the optical disk 1 may be reduced.

In another preferred embodiment, the CPU 14 handles the optical disk 1 as a single layer disk in a case where a second layer data recording process cannot be successfully performed on the optical disk 1, or the optical disk 1 is described as a single layer disk in the lead-in area so that second layer data recording cannot be performed. By handling the optical disk 1 as a single layer disk in such cases, contents recorded on the first layer of the optical disk 1 may not be wasted.

In another preferred embodiment, the CPU 14 records management information including the control status of the optical disk 1 in a predetermined area of the lead-in area so that the manner in which the dual layer disk is controlled may be determined and the optical disk 1 may be adequately controlled even when it is ejected and re-inserted into the information recording apparatus, for example.

In another preferred embodiment, the CPU 14 controls the background formatting process to continue from the first layer to the second layer and onward so as to enable a smooth transition from operations for a single layer disk to operations for a dual layer disk.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-318826 filed on Nov. 1, 2005, the entire contents of which are hereby incorporated by reference.

1. An information recording apparatus comprising:
a control unit that controls operations of recording user data on an information recording medium having a plurality of recording layers; wherein
when a next layer following a first layer of the recording layers remains unrecorded after the operations of recording user data are completed in response to a user data recording request, the control unit records temporary lead-out information after the recorded user data.

2. The information recording apparatus as claimed in claim 1, wherein
the control unit records lead-out information in at least an area of the next layer which area is positioned right above a lead-in area that is recorded on the first layer in an initial process.

3. The information recording apparatus as claimed in claim 1, wherein
the control unit records information indicating that the information recording medium is a single layer medium in a lead-in area of the first layer.

4. The information recording area as claimed in claim 1, wherein
the control unit records lead-out information in at least an area of the next layer which area is positioned right above a lead-in area that is recorded on the first layer in an initial process, and records information indicating that the information recording medium is a single layer medium in the lead-in area.

5. The information recording apparatus as claimed in claim 1, wherein
when an unrecorded area remains in the first layer and the next layer remains unrecorded after the operations of recording user data are completed in response to a user data recording request, and a next recording request to record user data on the next layer is issued, the control unit processes the next recording request as an error.

6. The information recording apparatus as claimed in claim 1, wherein
when data recording of the first layer is completed, and data recording of the next layer is initiated, the control unit records information indicating that the information recording medium is a dual layer medium in a lead-in area of the first layer.

7. The information recording apparatus as claimed in claim 1, wherein
the control unit records information indicating that the information recording medium is a dual layer medium in a lead-in area of the first layer when background formatting of the next layer is completed.

8. The information recording apparatus as claimed in claim 1, wherein
the control unit records information indicating that the information recording medium is a single layer medium in a lead-in area of the first layer when data recording of the next layer is not successfully performed.

9. The information recording medium as claimed in claim 1, wherein
the control unit records management information including control status information of the information recording medium in a predetermined area of a lead-in area of the first layer.

10. The information recording apparatus as claimed in claim 1, wherein
the control unit performs background formatting on the information recording medium starting from the first layer and continuing on to the next layer.
